(19) United States
(12) Patent Application Publication
(10) Pub. No.: US 2018/0247374 A1
(43) Pub. Date: Aug. 30, 2018

(54) System and Method for Computer Managed Funds to Outperform Benchmarks

(71) Applicant: Jianjun Li, Warren, NJ (US)

(72) Inventor: Jianjun Li, Warren, NJ (US)

(73) Assignee: Jianjun Li, Warren, NJ (US)

(21) Appl. No.: 15/640,468

(22) Filed: Jul. 1, 2017

Related U.S. Application Data
(60) Provisional application No. 62/465,100, filed on Feb. 28, 2017.

(51) Int. Cl. G06Q 40/06; G06N 3/08

(52) U.S. Cl. CPC G06Q 40/06; G06Q 40/04; G06N 3/08

(57) ABSTRACT

In order for an actively managed fund to outperform a target benchmark, it is important to seek investments with high excess returns. This invention provides a method and system for detecting potential excess returns and sorting out stocks with artificial intelligence. The method and system applies convolutional neural networks (CNN) to paired data patterns from stock and benchmark. Through deep learning, the system establishes the statistical relationship between the paired data patterns and the forward-looking excess returns. The CNN outputs represent the potential excess returns of individual stocks relative to the target benchmark. By allocating higher investment weights to stocks with higher potential excess returns, the expected return of the portfolio will be greater than the target benchmark.

### BACKGROUND OF THE INVENTION

Active portfolio management and passive portfolio management are the two main investment strategies. Active portfolio management relies on fund managers to make investment decisions while passive portfolio management basically aims to mimic the investment holdings of a particular benchmark or index. Morningstar published reports to track the performance of U.S. active managers against their passive peers. The study finds that actively managed funds have generally underperformed their passive counterparts. The fact tells us even for the professional fund managers it's very hard to beat the market consistently.

Modern portfolio theory, introduced by Harry Markowitz in 1952, is the cornerstone of active portfolio management. The theory was implemented in various financial systems for fund management or portfolio optimization. Although good works have been done in the area, constructing an optimal portfolio remains challenging. Part of the reason is that the parameters such as returns, risk and correlation used in the models are historical data that are not always a good guide to the future.

Artificial intelligence advanced significantly in recent years thanks for the new deep learning algorithms, big data and more powerful computers. Computers with advanced artificial intelligence can analyze data deeper and faster, can self-learn from real world data or learn from successful fund managers. It would be advantageous to develop a system that can leverage advanced artificial intelligence, make better investment decisions and beat the market in a systematic way.

### SUMMARY OF THE INVENTION

Deep learning is an approach to machine learning and achieved great success in recent years, especially in the field of computer vision, face recognition and autonomous driving. In those applications, the source data or objects are mostly images and neural networks are used to recognize the images or patterns.

This invention presents a new system and method that uses convolutional neural networks (CNN) to recognize data patterns and learn the statistic relationships between various data patterns and potential excess returns. After training, the system predicts and ranks the potential excess returns of all candidate stocks, then optimizes the portfolio by allocating more funds to stocks with higher excess returns. The core task of active portfolio management, portfolio construction and optimization, is transferred to pattern recognition which is performed by computers.

First, the system receives the fundamental, technical and economic information associated with the stocks, benchmarks and markets. The information is then transformed to data frames like a series of images.

Then the convolutional neural networks scan the data frames by considering a data frame as an image. With multi layers and deep learning networks, the CNN system learns what features or patterns drive stock prices higher in a relative fashion, specifically, the potential excess return from each stock against the same benchmark.

Finally all candidate stocks are ranked in descending order according to their CNN outputs which represent the potential excess returns of individual stocks. Stocks with negative CNN outputs may be filtered out. Portfolio construction or optimization is performed by allocating higher investment weights to stocks with higher CNN outputs. Risk management and portfolio strategies can also be applied by individual fund managers.

### BRIEF DESCRIPTION OF THE DRAWINGS

FIG. 1 is a flow diagram showing a method in accordance with an embodiment of the present invention.

FIG. 2 is an illustration of a system for showing the modules in accordance with an embodiment of the present invention.

FIG. 3 is an illustration of a system for showing portfolio construction or optimization in accordance with an embodiment of the present invention.

FIG. 4 is a schematic diagram illustrating architecture of the convolutional neural networks in accordance with an embodiment of the present invention.

FIG. 5 is a block diagram showing a computer system, constructed and operative in accordance with an embodiment of the present invention.

### DETAILED DESCRIPTION OF THE EMBODIMENTS

The subject matter of the present invention is described with specificity herein to meet statutory requirements. Forty fundamental, technical and market data components are used in the description. However, the description itself is not intended to limit the scope of this patent. Rather, the inventor has contemplated that the claimed subject matter might also be embodied in other ways, to include different steps, use daily or weekly or monthly data, use more or less data components for the neural networks.

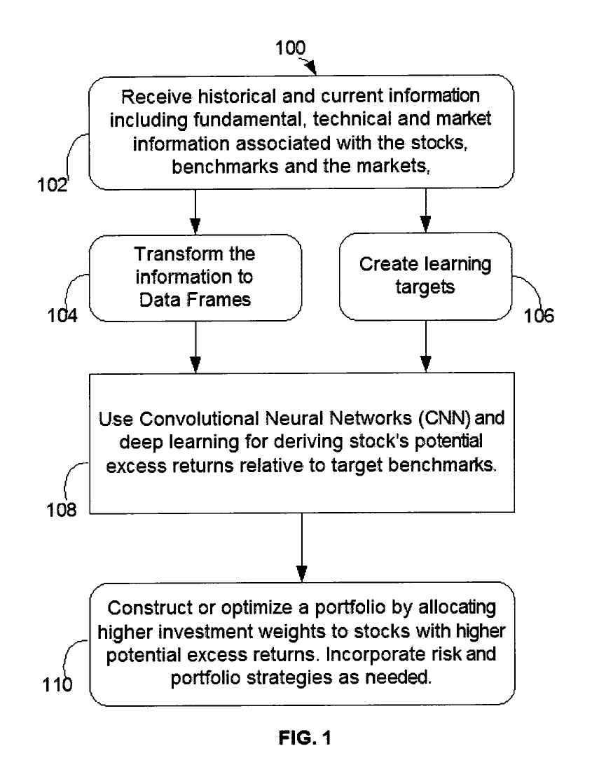

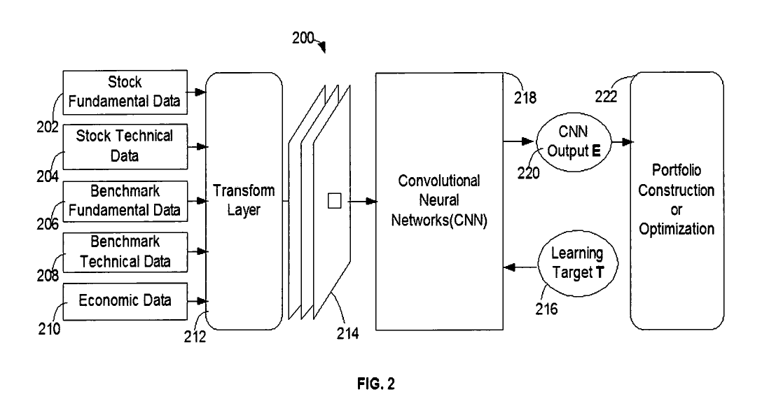

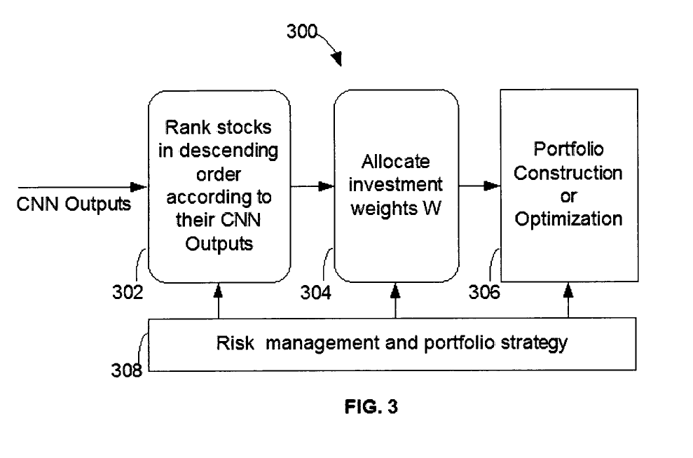

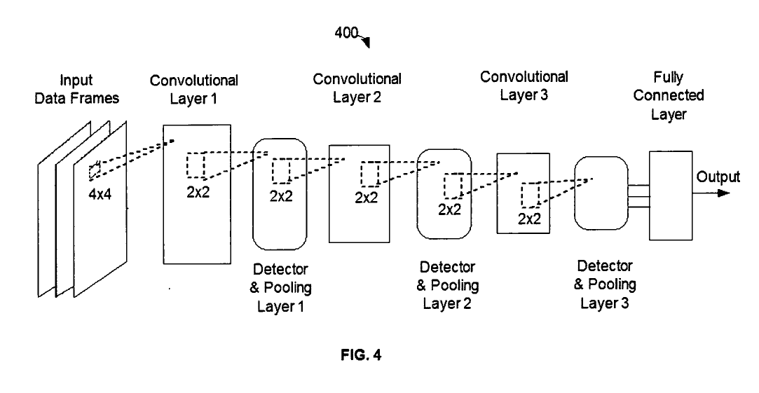

Referring now to FIG. 1, a flow diagram is provided that illustrates a method 100 for using convolutional neural networks to derive the potential excess returns of individual stocks relative to a benchmark, constructs a new portfolio or optimizes an existing portfolio to outperform the target benchmark based on the outputs of the convolutional neural networks. The method 100 may be performed with steps 102, 104, 106, 108 and 110 as shown in FIG. 1. Step 102 receives historical and current information including fundamental, technical and market information associated with the stocks, benchmarks and the markets, Step 102 is further described in system 202, 204, 206, 208 and 210 of FIG. 2. Step 104 transforms the collected information to data frames suitable for the convolutional neural networks, which is further described in 212 and 214 of FIG. 2. In order for the neural network to know what to output, a target needs to be provided during neural network training or machine learning. Step 106 produces the forward-looking excess returns as the target data. In FIG. 1, 108 is a multi-layer convolutional neural network system with deep learning which is further described in system 200 of FIG. 2 and 400 of FIG. 4. The last step 110 of method 100 of FIG. 1, is to construct or optimize the portfolio using the outputs from the convolutional neural networks. Step 110 is further described in system 300 of FIG. 3.

Referring to FIG. 2, a schematic illustration of a system 200 constructed in accordance with an embodiment of the present invention.

Stock Fundamental Data 202 of FIG. 2 are the core fundamentals of the company for each candidate stock. The following implementation, as an illustration example, takes 24 fundamental data elements with 10 year historical and weekly data. More or less data elements, longer or shorter history, daily or monthly data can also be used in other embodiments.

This invention detects potential excess return and excess return is determined by the stock return and the benchmark return. To the convolutional neural networks, the historical differences between the stock and the benchmark are found more meaningful than the real values. To produce the data patterns that the convolutional neural networks can learn effectively, each fundamental stock element is paired with the same type of data element of the benchmark. For example, PEₛ is the stock's Price to Earnings Ratio at time t, which is paired with the average Price to Earnings Ratio of the benchmark, PE_{b}, at time t. The difference or the ratio of the paired elements is used for training the convolutional neural networks. Each technical stock element is also paired with the same technical element of the benchmark. In addition, each technical indicator is converted to −1 or 0 or 1 so that the convolutional neural networks can effectively recognize the technical charts. All components from the last 52 weeks are transformed to a 2-dimensional data frame so that the convolutional neural networks can see the changes of the data patterns when reading the data frame as an image.

Let Aᵢ(t) denote the ith fundamental data element of the stock at time t:

A₁(t)=PEₛ
Where: PEₛ is the stock's Price to Earnings Ratio at time t.

A₂(t)=PSₛ
Where: PSₛ is the stock's Price to Sales Ratio at time t.

A₃(t)=PBₛ
Where: PBₛ is the stock's Price to Book Value Ratio at time t.

A₄(t)=PCₛ

Where: PCₛ is the stock's Price to Cash Flow Ratio at time t.

A₅(t)=RGₛ
Where: RGₛ is the stock's yearly Revenue Growth rate at time t.

A₆(t)=EGₛ
Where: EGₛ is the stock's yearly Earnings Growth rate at time t.

A₇(t)=DYₛ
Where: DYₛ is the stock's Dividend Yield at time t.

A₈(t)=POₛ
Where: POₛ is the stock's Payout at time t.

A₉(t)=ROAₛ
Where: ROAₛ is the stock's Return On Assets at time t.

A₁₀(t)=ROEₛ
Where: ROEₛ is the stock's Return On Equity at time t.

A₁₁(t)=OMₛ
Where: OMₛ is the stock's Operating Margin at time t.

A₁₂(t)=PMₛ
Where: PMₛ is the stock's Profit Margin at time t.

A₁₃(t)=DEₛ
Where: DEₛ is the stock's Debt/Equity Ratio at time t.

A₁₄(t)−SSRₛ
Where: SSRₛ is the stock's Shares Short Ratio at time t.

A₁₅(t)=MARₛ
Where: MARₛ is the stock's Mean Analyst. Rating at time t.

A₁₆(t)=EPSSₛ
Where: EPSSₛ is the stock's Earnings Per Share Surprise Percent at time t.

A₁₇(t)=EBITₛ
Where: EBITₛ is the stock's Earnings Before Interest and Tax at time t.

A₁₈(t)=SRₛ
Where: SRₛ is the stock's Sharpe Ratio at time t.

A₁₉(t)=ROSₛ
Where: ROSₛ is the stock's Return on Sales at time t.

A₂₀(t)=EPST7ₛ
Where: EPST7, is the past 7 days Earnings Per Share Estimate change at time t.

A₂₁(t)=EPST30ₛ
Where: EPST30ₛ is the past 30 days Earnings Per Share Estimate change at time t.

A₂₂(t)=EPST60ₛ
Where: EPST60ₛ is the past 60 days Earnings Per Share Estimate change at time t.

A₂₃(t)=EPST90ₛ
Where: EPST90ₛ is the past 90 days Earnings Per Share Estimate change at time t.

A₂₄(t)=PEGₛ
Where: PEGₛ is the stock's Price to Earnings Ratio divided by Growth Rate at time t. Stock Technical Data 204 of FIG. 2 are technical analysis data for each candidate stock. In this implementation example, we use 8 technical indicators with 10 year history and weekly data. More or less technical indicators, longer or shorter history, daily or monthly data can also be used in other embodiments.

Let Bᵢ(t) denote the ith technical data element of the stock at time t:

B₁(t)=MA30ₛ
Where: MA30, is the stock's 30 day Moving Average Indicator at time t.

B₂(t)=MA50ₛ
Where: MA50, is the stock's 50 day Moving Average Indicator at time t.

B₃(t)=MA200ₛ
Where: MA200ₛ is the stock's 200 day Moving Average Indicator at time t.

B₄(t)=RSIₛ
Where: RSIₛ is the stock price Relative Strength Index at time t.

B₅(t)=ADₛ
Where: ADₛ is the stock's Accumulation/Distribution Indicator at time t.

B₆(t)=AOSCₛ
Where: AOSCₛ is the stock's price Aroon Oscillator at time t.

B₇(t)=RSTBₛ
Where: RSTBₛ is the stock's Relative Strength to the Benchmark at time t.

B₈(t)=BETAₛ
Where: BETAₛ is the stock's volatility in relation to the benchmark at time t.

Benchmark Fundamental Data 206 of FIG. 2 are the average of the fundamental data of the benchmark constituents. For market value weighted benchmarks, the benchmark fundamental values are market value weighted average.

Let Cᵢ(t) denote the ith fundamental data element of the benchmark at time t:

C₁(t)=PE_{b}
Where: PE_{b} is the average Price to Earnings Ratio of the benchmark at time t.

C₂(t)=PS_{b}
Where: PS_{b} is the average Price to Sales Ratio of the benchmark at time t.

C₃(t)=PB_{b}
Where: PB_{b} is the average Price to Book Value Ratio of the benchmark at time t.

C₄(t)=PC_{b}
Where: PC_{b} is the average Price to Cash Flow Ratio of the benchmark at time t.

C₅(t)=RG_{b}
Where: RG_{b} is the average yearly Revenue Growth rate of the benchmark at time t.

C₆(t)=EG_{b}
Where: EG_{b} is the average yearly Earnings Growth rate of the benchmark at time t.

C₇(t)=DY_{b}
Where: DY_{b} is the average Dividend Yield of the benchmark at time t.

C₈(t)=PO_{b}
Where: PO_{b} is the average Payout of the benchmark at time t.

C₉(t)=ROA_{b}
Where: ROA_{b} is the average Return On Assets of the benchmark at time t.

C₁₀(t)=ROE_{b}
Where: ROE_{b} is the average Return On Equity of the benchmark at time t.

C₁₁(t)=OM_{b}
Where: OM_{b} is the average Operating Margin of the benchmark at time t.

C₁₂(t)=PM_{b}
Where: PM_{b} is the average Profit Margin of the benchmark at time t.

C₁₃(t)=DE_{b}
Where: DE_{b} is the average Debt/Equity Ratio of the benchmark at time t.

C₁₄(t)=SSR_{b}
Where: SSR_{b} is the average Shares Short Ratio of the benchmark at time t.

C₁₅(t)=MAR_{b}
Where: MAR_{b} is the average Mean Analyst Rating of the benchmark at time t.

C₁₆(t)=EPSS_{b}
Where: EPSS_{b} is the average Earnings Per Share Surprise Percent of the benchmark at time t.

C₁₇(t)=EBIT_{b}
Where: EBIT_{b} is the average Earnings Before Interest and Tax of the benchmark at time t.

C₁₈(t)=SR_{b}
Where: SR_{b} is the average Sharpe Ratio of the benchmark at time t.

C₁₉(t)=ROS_{b}
Where: ROS_{b} is the average Return on Sales of the benchmark at time t.

C₂₀(t)=EPST7_{b}
Where: EPST7_{b} is the past 7 days average Earnings Per Share Estimate change of the benchmark at time t.

C₂₁(t)=EPST30_{b}
Where: EPST30_{b} is the past 30 days average Earnings Per Share Estimate change of the benchmark at time t.

C₂₂(t)=EPST60_{b}
Where: EPST60_{b} is the past 60 days average Earnings Per Share Estimate change of the benchmark at time t.

C₂₃(t)=EPST90_{b}
Where: EPST90_{b} is the past 90 days average Earnings Per Share Estimate change of the benchmark at time t.

C₂₄(t)=PEG_{b}
Where: PEG_{b} is the average Price to Earnings Ratio divided by Growth Rate of the benchmark at time t.

Benchmark Technical Data 208 of FIG. 2 are technical indicators for the benchmark. In this implementation example, we use 4 technical indicators. More or less technical indicators can also be implemented in other embodiments.

Let Dᵢ(t) denote the ith technical data element of the benchmark at time t:

D₁(t)=MA30_{b}
Where: MA30_{b} is the 30 day Moving Average of the benchmark price at time t.

D₂(t)=MA50_{b}
Where: MA50_{b} is the 50 day Moving Average of the benchmark price at time t.

D₃(t)=MA200_{b}
Where: MA200_{b} is the 200 day Moving Average of the benchmark price at time t.

D₄(t)=RSI_{b}
Where: RSI_{b} is the benchmark's price Relative Strength Index at time t.

Economic Data 210 of FIG. 2 are economic or market information that may have influence on the stock and benchmark. Four economic data elements are used in this implementation example. More or less economic data can also be implemented in other embodiments.

Let Mᵢ(t) denote the ith data element at time t:

M₁(t)=INT
Where: INT is the Interest Rate (10 year notes yield) at time t.

M₂(t)=GDP
Where: GDP is the Gross Domestic Product at time t.

M₃(t)=VIX
Where: VIX is the CBOE Volatility Index at time t.

M₄(t)=YCURVE
Where: YCURVE is the Yield Curve or interest rates across different contract lengths.

System 200 of FIG. 2 has a Transform Layer 212 which transforms the raw data sets A, B, C, D, M into a data set X so that the convolutional neural networks can effectively learn the relationships between the input data and the excess returns. The Transform Layer comprises:

Constructing Fundamental Components:

X₁(t) to X₂₄(t) are respectively constructed to represent the deviation of the stock's fundamental data and the benchmark average. In one embodiment, the fundamental components X₁(t) to X₂₄(t) can be respectively constructed as the difference between Aᵢ(t) and Cᵢ(t), where i from 1 to 24. In other embodiments, the fundamental components X₁(t) to X₂₄(t) can be constructed as the ratio of Aᵢ(t) over Cᵢ(t) or other deviation calculations, where i from 1 to 24. It is the deviation, not the absolute value, that the convolutional neural networks learn and establish the relationship between the fundamental data and the potential excess returns.

Constructing Stock Technical Components: X₂₅(t) to X₃₂(t):

Technical analysis is transformed to values for the convolutional neural networks to learn. Below is an example how to transform technical analysis to values:

X₂₅(t)=1 if the stock price at time t is higher than B₁(t),

X₂₅(t)=0 if the stock price at time t is equal to B₁(t),

X₂₅(t)=−1 if the stock price at time t is lower than B₁(t).

X₂₆(t)=1 if the stock price at time t is higher than B₂(t),

X₂₆(t)=0 if the stock price at time t is equal to B₂(t),

X₂₆(t)=−1 if the stock price at time t is lower than B₂(t).

X₂₇(t)=1 if the stock price at time t is higher than B₃(t),

X₂₇(t)=0 if the stock price at time t is equal to B₃(t),

X₂₇(t)=−1 if the stock price at time t is lower than B₃(t).

X₂₈(t)=1 if B₄(t) or RSI indicates oversold, typically the value is less than 20,

X₂₈(t)=0 if B₄(t) or RSI is greater than 20 but less than 80,

X₂₈(t)=−1 if B₄(t) or RSI indicates overbought, typically the value is greater than 80.

X₂₉(t)=1 if B₅(t) is above 0 or the AD line shows bullish,

X₂₉(t)=0 if B₅(t) is 0 or the AD line shows neutral,

X₂₉(t)=−1 if B₅(t) is below 0 or the AD line shows bearish.

X₃₀(t)=1 if B₆(t) is above 50 or the Aroon Oscillator shows upward momentum,

X₃₀(t)=0 if B₆(t) is lower than 50 and greater than −50,

X₃₀(t)=−1 if B₆(t) is below −50 or the Aroon Oscillator shows downward momentum.

X₃₁(t)=1 if B₇(t) is above the mid line,

X₃₁(t)=0 if B₇(t) is in the mid line,

X₃₁(t)=−1 if B₇(t) is below the mid line.

X₃₂(t)=1 if B₈(t) is Less than 1,

X₃₂(t)=0 if B₈(t) is 1,

X₃₂(t)=−1 if B₈(t) is above 1.

Constructing Benchmark Technical Components: X₃₃(t) to X₃₆(t):

X₃₃(t)=1 if the benchmark price at time t is higher than D₁(t),

X₃₃(t)=0 if the benchmark price at time t is equal to D₁(t),

X₃₃(t)=−1 if the benchmark price at time t is lower than D₁(t).

X₃₄(t)=1 if the benchmark price at time t is higher than D₂(t),

X₃₄(t)=0 if the benchmark price at time t is equal to D₂(t),

X₃₄(t)=−1 if the benchmark price at time t is lower than D₂(t).

X₃₅(t)=1 if the benchmark price at lime t is higher than D₃(t),

X₃₅(t)=0 if the benchmark price at time t is equal to D₃(t),

X₃₅(t)=−1 if the benchmark price at time t is lower than D₃(t).

X₃₆(t)=1 if D₄(t) or the benchmark RSI indicates oversold, typically the value is less than 20,

X₃₆(t)=0 if D₄(t) or the benchmark RSI is greater than 20 but less than 80,

X₃₆(t)=−1 if D₄(t) or the benchmark RSI indicates overbought, typically the value is greater than 80.

Constructing Economic Components:

X₃₇(t) to X₃₉(t):

X₃₇(t)=M₁(t)

X₃₈(t)=M₂(t)

X₃₉(t)=M₃(t).

Constructing Yield Curve Components:

X₄₀(t) to X₄₀(ttm51)

Yield Curve M₄ at time t is digitized to X₄₀(t), X₄₀(ttm1) . . . X₄₀(ttm51) representing the interest rates with different time to maturity, ttm1, ttm2, ttm51.

Constructing Data Frames:

Data frames 214 of FIG. 2, are created as follows:

The first frame, F(t), contains data components from current week to 51 weeks ago:

$$F ( t ) = \vert \begin{matrix}{X}_{1} ( t ) & {X}_{1} ( t - 1 ) & … & {X}_{1} ( t - 51 ) \\ {X}_{2} ( t ) & {X}_{2} ( t - 1 ) & … & {X}_{2} ( t - 51 ) \\ … & … & & … \\ {X}_{39} ( t ) & {X}_{39} ( t - 1 ) & … & {X}_{39} ( t - 51 ) \\ {X}_{40} ( t ) & {X}_{40} ( ttm 1 ) & … & {X}_{40} ( ttm 51 )\end{matrix} \vert$$

The second frame, F(t−1), contains data components from 1 week ago to 52 weeks ago:

$$F ( t - 1 ) = \vert \begin{matrix}{X}_{1} ( t - 1 ) & {X}_{1} ( t - 2 ) & … & {X}_{1} ( t - 52 ) \\ {X}_{2} ( t - 1 ) & {X}_{2} ( t - 2 ) & … & {X}_{2} ( t - 52 ) \\ … & … & & … \\ {X}_{39} ( t - 1 ) & {X}_{39} ( t - 2 ) & … & {X}_{39} ( t - 52 ) \\ {X}_{40} ( t - 1 ) & {X}_{40} ( ttm 1 ) & … & {X}_{40} ( ttm 51 )\end{matrix} \vert$$

All other data frames are produced in the same way by shifting 1 week from frame to frame. Data frames are input to the convolutional neural networks one by one.

Learning Targets 216 of FIG. 2 are produced to represent the potential excess returns of each stock that exceed the benchmark returns at the same time period.

T(t)=RoRₛ−RoR_{b}
Where:
T(t): The target at time t for a stock.
RoRₛ: The stock's average weekly Rate of Return from t to t+P.
RoR_{b}: The benchmark's average weekly Rate of Return from t to t+P.
P: The forward-looking period, changeable from 1 week to 52 weeks.

The Convolutional Neural Networks (CNN) 218 of FIG. 2 are multi-layers deep networks. Learning is carried out at each layer. Supervised learning with target 216 of FIG. 2 is conducted at the last stage. The convolutional neural networks 218 of FIG. 2 are further illustrated in 400 of FIG. 4. As shown in FIG. 4, in an embodiment of the present application, the convolutional neural networks may comprise multiple layers, such as 3 convolutional layers, 3 detector and pooling layers and a fully connected layer in this embodiment. Data frames are scanned in with 4×4 window in the first layer then 2×2 in other layers in this embodiment.

In addition, in an embodiment of the present application, multiple convolution kernels with variable sizes may be used. Back-test, which tests the system performance with historical or real time data, may also be conducted for selecting the optimal CNN configuration for individual markets or benchmarks.

Output E 220 of FIG. 2 is the neural network output that represents the forward looking excess return of the stock at time t when the input data frame is F(t).

To create a portfolio with N stock positions and one cash position, create L (L is much greater than N) stock systems 200 of FIG. 2, one for each candidate stock.

Referring to FIG. 3 now, all CNN outputs, totally L, are ranked in descending order in 302 and the first N stocks are retained:

E¹>=E²>= . . . >=E^{N}

Where:

E¹ is the CNN output of stock1 that has the highest value,

E² is the CNN output of stock2 that has the 2^{nd} highest value,

. . .

E^{N} is the CNN output of stockN that has the lowest value among all N stocks.

For a mutual fund, the maximum weight or percent invested to a single stock is regulated. In other type of funds, the fund managers may set a maximum weight as well. Let W^{max} denote the maximum weight allowed by the portfolio, 304 of FIG. 3 allocates the weights to individual stocks in the same order as their CNN outputs:

W^{max}=W¹>=W²>= . . . >=W^{N}>=w^{min}

Where:

W^{max} is the maximum weight of a single stock, pre-set by fund manager or regulatory rules,

W¹ is the investment percent to stock1,

W² is the investment percent to stock2,

W^{N} is the investment percent to stockN,

W^{min} is the minimum weight of a single stock, pre-set by fund manager or regulatory rules,

W^{C} is the percentage of the Cash amount, and

Σᵢ₌₁^{N}Wⁱ+W^{C}=100%

The expected portfolio return Rₚ relative to the benchmark is calculated in 306 of FIG. 3:

Rₚ=Σᵢ₌₁^{N}Wⁱ×E¹

if Rₚ<0 which indicates the portfolio would underperform the target benchmark, then reduce the weight of the lowest ranking stock by ΔW:

W^{N}−ΔW−>W^{N}

If the weight of the lowest ranking stock reaches the minimum level, reduce the weight from the second lowest ranking stock.

Then add ΔW back to the highest ranking stock:

W¹+ΔW−>W¹

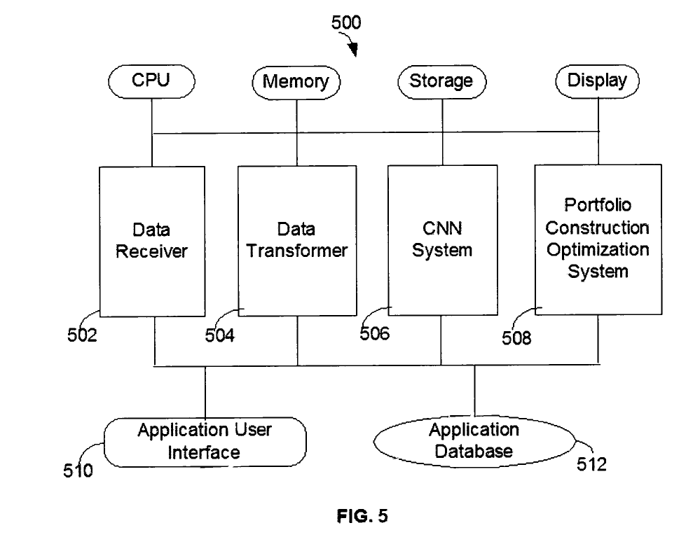

If the weight of the highest ranking stock already reaches the maximum, add ΔW back to the second highest ranking stock, so on so forth. A W=0.01% is preset by the program and changeable through the Application User Interface 510 of FIG. 5.

Repeat the above process until

W^{max}>=W¹>W²>= . . . >=W^{N}>W^{min} and

Σᵢ₌₁^{N}Wⁱ+W^{C}=100% and

Rₚ=Σᵢ₌₁^{N}Wⁱ×Eⁱ>0

When Rₚ>0, the portfolio would outperform the target benchmark by probability, which is the goal of this invention.

In addition, risk management and portfolio strategies may be incorporated to the portfolio optimization process. For example, in an embodiment, the Tracking Error or the standard deviation of excess return may be calculated, then the Information Ratio, which is the CNN output divided by the Tracking Error, is ranked in descending order. Stocks with higher Information Ratios may be allocated more funds, making the portfolio optimization risk-adjusted.

The present invention can be implemented in various forms of hardware, software, firmware, or a combination thereof. In one embodiment, the present invention can be implemented in a computer. In one embodiment of the invention, this computer readable program and storage device can be made available to fund managers or investors.

Referring to FIG. 5, in one embodiment, the present invention is implemented in a computer system 500, comprising:

Data Receiver 502 that receives fundamental, technical and market information from the internet or from another connected system;

Data Transformer 504 that transforms the information to data frames with each data frame containing a window of data components including the fundamental components, the stock technical components, the benchmark technical components, the economic components, the yield curve components;

Convolutional Neural Networks (CNN) 506 that scan the data frames, learn and recognize various data patterns and link the data patterns with the potential excess returns; Portfolio Construction/Optimization system 508 that constructs new portfolios or optimizes existing portfolios based on the potential excess returns derived from the convolutional neural networks;

Application User Interface 510 that provides the graphical interface for users to configure the system including: selecting a target benchmark, adding or dropping input components, adding or dropping CNN layers, adding or dropping risk management and portfolio strategies, monitoring the operation of the system;

Application Database 512 that stores the fundamental, technical and market data, the data frames and the learning targets, the convolutional neural networks created and trained for individual stocks, the portfolios and benchmarks involved;

Hardware such as CPU, Memory, Storage, Display.

What is claimed is:

1. A method that detects potential excess returns of individual stocks against a benchmark, the method comprising: producing data patterns by pairing stock data elements with the corresponding benchmark data elements, transforming the paired data to 2-dimensional images or data frames, constructing the convolutional neural networks (CNN) to recognize the statistical relationship between the paired data patterns and the forward-looking excess returns, ranking the CNN outputs to sort out stocks that would outperform the benchmark.

2. The method of claim 1, wherein the data patterns are produced in such a way that the convolutional neural networks can effectively detect the data edges or patterns that are meaningful to the forward-looking excess returns, comprising:
each fundamental stock element is paired with the same type of data component of the benchmark, the difference or the ratio of the paired elements is produced;
each technical stock element is paired with the same technical element of the benchmark, in addition, each technical indicator is converted to −1 or 0 or 1 so that the convolutional neural networks can effectively recognize the technical charts;
all components from the last 52 weeks are transformed to a 2-dimensional data frame so that the convolutional neural networks can see the changes of the data patterns when reading the data frame as an image.

3. The method of claim 1, wherein the convolutional neural networks (CNN) are constructed to detect potential excess returns, accomplished by:
feeding the CNN with paired data patterns from stock and benchmark;
setting up the CNN with forward-looking excess returns as the learning target;
establishing the statistical relationship between the paired data patterns and the forward-looking excess returns through deep learning.

4. A computer system that implements the method of claim 1 for predicting potential excess returns of individual stocks relative to the target benchmark, comprising:
data receiver and transformer that produce the required data patterns and learning targets;
convolutional neural networks with configurable multi-filters and multi-layers;
computer software for conducting deep learning and operation;
computer hardware with CPU, memory, storage, display.
